(19) United States
(12) Patent Application Publication
(10) Pub. No.: US 2010/0248979 A1
(43) Pub. Date: Sep. 30, 2010

(54) REVERSED FLOW THROUGH PLATFORM FOR RAPID ANALYSIS OF TARGET ANALYTES WITH INCREASED SENSITIVITY AND SPECIFICITY AND THE DEVICE THEREOF

(75) Inventor: Joseph Tam, North Point (HK)

Correspondence Address: FAY SHARPE LLP, 1228 Euclid Avenue, 5th Floor, The Halle Building, Cleveland, OH, 44115, US

(73) Assignee: DIAGCOR BIOSCIENCE INCORPORATION LTD., North Point (HK)

(21) Appl. No.: 12/681,147

(22) PCT Filed: Oct. 3, 2008
(86) PCT No.: PCT/IB2008/054044

§ 371 Date: Apr. 1, 2010

Related U.S. Application Data
(60) Provisional application No. 60/977,367, filed on Oct. 3, 2007.

(51) Int. Cl. C40B 30/04; C40B 60/12

(52) U.S. Cl. 506/9; 506/39

(57) ABSTRACT

A reversed flow-through device for rapid analysis of target analytes and method thereof, comprises one or more reaction chambers, each of which comprises one or more membranes for immobilizing capture molecules; controlling elements that can be regulated to maintain the reaction chamber in controlled conditions; connecting elements for connection to a power supply and control unit that can regulate and maintain the controlled conditions; and liquid delivery elements capable of accepting and removing solution, wherein the solution is maintained in a flow direction that flows against gravitational force, thereby providing higher sensitivity of analytes detection.

Throughout this application, various publications are referenced. Disclosures of these publications in their entireties are hereby incorporated by reference into this application in order to more fully describe the state of the art to which this invention pertains.

### FIELD OF INVENTION

The present invention discloses a novel reversed flow through hybridization method and devices for making rapid, definitive identification of different analytes utilizing an array or other formats for increased sensitivity and specificity.

### BACKGROUND OF THE INVENTION

The principle of flow-through hybridization is to use direct flow-through mechanism in which target molecules such as nucleic acid molecules pass through membrane pores of about 0.45 micron in membranes of about 160 micron in thickness. Single strand DNA is allowed to come in close contact with corresponding capture complementary DNA or RNA sequences immobilized inside the membrane pores so that the target sequence can be effectively detected in high sensitivity and specificity. It has been proven repeatedly that the direct flow-through process disclosed in its original patent (U.S. Pat. No. 5,741,687) and in subsequent reports is much superior to conventional hybridization method in sensitivity, efficiency, speed and cost effectiveness as well as user friendliness. However, the direct flow-through format and the embodiment described and disclosed are far from perfect to achieve the highest possible sensitivity and specificity. The present invention using a reversed flow-through mechanism provides substantial improvements.

Accurate genotyping by DNA analysis such as HLA typing is essential for matching donor and recipient in organ or marrow transplantation (Thomas, 1983) to prevent development of acute graft-versus-host disease (GVHD). Recent studies have demonstrated DNA genotyping can provide more accurate and definitive result (Kaneshige et. al., 1993; Chow and Tonai, 2003; Mach et al., 2004). Results of HLA-A, B, DQ, DR and DP genotyping provided data for accurate matching which is necessary in selecting potential organ donors (Tam, 1998; 2004; 2005; 2006).

However, in the cases of extremely high heterogeneities of HLA complex, the number of polymorphic SNP (single nucleotide polymorphism) needed to achieve comprehensive differentiation is very high by DNA method because many SNPs do not result in polymorphic protein. Hence the number of HLA proteins expressed will be much less than the number of SNPs. If a full set of antibodies can be made, a set of Antibody Array and/or HLA antigen array is most appropriate for HLA protein typing to generate full HLA profile for an individual. Nowadays, these sets of antibodies or proteins can be made available easily by reverse genetic engineering and monoclonal antibody expression and screening. Depending on the number of antibodies/antigens used, the typing classification can be set from low (degenerate) to complete differentiation. In fact standard serological typing (Kaneshige et. al., 1993; Chow and Tonai, 2003; Mach et al., 2004) of HLA has been done for many years. The present invention provides improved methods and devices for rapid and cost efficient process of conducting protein analysis/typing using a flow-through protein array format. In addition to HLA typing, dot-blot, reverse dot-blot or slot blot can be used for other protein systems for rapid analysis.

### SUMMARY OF THE INVENTION

The present invention provides a reversed flow-through device for rapid analysis of nucleic acids, proteins and/or any analytes of interest, comprising: (a) one or more reaction chambers, each of which comprises one or more membranes for immobilizing capture molecules capable of binding target analytes with high specificity and affinity; (b) controlling elements that can be regulated to maintain the reaction chamber in controlled conditions favorable for specific binding; (c) connecting elements for connection to a power supply and control unit that can regulate and maintain the controlled conditions; and (d) liquid delivery elements capable of accepting and removing solution to and from the reaction chambers, wherein the solution flows against gravitational force and flows through the membrane from one end to another end so that target analytes pass through the capturing molecules immobilized on the membrane, thereby providing highest sensitivity of analytes detection.

The reversed flow through process described herein ensures the solution is flowed from a lower level up to a higher level against the gravitational force. Hence uniform flow rate can be achieved laterally across the whole membrane from one end to the other. Equal amount of sample is thus passed through the multiple probes immobilized onto the whole membrane area. Consequently, this will ensure the accuracy of relative quantitative measurements of different analytes in the same sample captured by the corresponding probes in the array on the membrane. Furthermore, using the flow direction laterally across the membrane shall increase the effective capture of the target molecule by many folds (see text below for the theoretical calculation in detailed description of invention).

The present invention also provides a reversed lateral flow-through analysis system comprising a plurality of the reversed flow-through device described above, wherein the devices are connected to a power supply and control unit capable of supplying energy and providing independently regulatory control to the devices.

The present invention also provides a method of performing rapid analytes detection, comprising the steps of: (a) obtaining a sample comprising a target molecule; (b) applying the sample to an array comprising capture molecules that will capture the target molecule on the array, wherein the sample flows through the array from one end to another end of the array in a flow direction that is against gravitational force; and (c) detecting the captured target molecule on the array. Representative examples of target molecule include, but are not limited to, protein, nucleic acid, peptide, or any biological molecules of interest.

### BRIEF DESCRIPTION OF THE DRAWINGS

FIG. 1 shows an exploded view of a hybridization device of the present invention.

FIG. 2 shows another embodiment of a reversed lateral flow reaction chamber assembly as described herein.

FIG. 3 shows protein cancer markers commonly used for clinical diagnosis.

FIG. 4 shows examples of arrays of protein cancer biomarkers. Panels A to D are profiles of some cancer samples; panel E is a normal sample.

FIG. 5 shows some of the SNP arrays used in the reversed flow-through system for CYP2D6 genotype determination.

FIG. 6 shows a method of determining different extent of methylation on the CpG islands; the Methylation Specific PCR and Flow-through Hybridization assay. The presence of methylation on DNA strands can be detected by disulfide modification by which the CmG is changed into TG whereas unmethylated CG stays unchanged. Hence the ratio of TG to CG of a given CG islands can either be determined by real time quantitative methylation specific PCR (MS-PCR or QMS-PCR) or by co-amplification followed by hybridization with methylation-specific probe and unmethylation-specific probe as described herein. After amplification, unmethylated strand will be captured and seen only with the unmethylated probe as shown in Array A. Methylated strand will be seen at Array B. In cases where all genes studied are not methylated, none of the methylated dots will show any signal as in Array C. On the other hand, various profiles will be seen corresponding to different extent of methylation in individual genes. If proper set of genes are selected, one can probably relate differences in intensity profiles to certain diseases such as cancers.

FIG. 7 shows candidate genes for hypermethylation assays.

FIG. 8 shows some of the primer and probe sequences used for methylation detection.

FIG. 9 lists some of the prospective marker genes for methylation assays and their possible association to cancers.

FIG. 10 shows the scheme of the one-step hybridization process.

FIG. 11 shows another embodiment of the flow-through process: hybridization reaction in solution before flow-through capture of the target analytes.

### DETAILED DESCRIPTION OF THE INVENTION

The present invention provides methods and devices for rapid detection of analytes such as protein, nucleic acids and certain macromolecules and small molecules of biological importance provide that capturing molecules can be found and used to capture the corresponding target(s). In general, the device disclosed herein is a reversed flow-through device comprising (1) one or more reaction chambers, each of which contains one or more membrane or array having capture probes designed to capture the target molecules, and (2) a delivery system by which liquid can be directed to flow through the membranes for the target molecules to react with the probes, and unbound molecules can be removed by washing or drain out with appropriate mechanism such as solution pumps. In another embodiment, the drainage system can be any material that is capable of absorbing enough liquid from the chamber after reaction. If the capture adducts are not by themselves signal generating, additional components for color generating such as affinity-enzyme conjugates (e.g. Avidin-HRP or antibody-AP etc.) shall be added for signal amplification and detection. To increase the sensitivity of detection, sample solution containing target molecules can be recirculated through the array or membrane for repeated capture process.

The novelty of this invention which is not achievable by other flow-through systems disclosed in prior arts is that: (1) uniform flow across the entire length of the membrane where different probes are immobilized can be easily achieved because the flow from lower level up against the gravitational force shall keep the solution front a straight line horizontally as well as prevent possible trapping of air bubbles in the membrane, thus ensuring uniform passage of solution for target molecules/capture probes interaction, and (2) the flow rate in the present invention is controlled with positive driving force (e.g. by pumping) and therefore can be controlled accurately. In contrast, in the normal lateral flow system (e.g. conventional fast immuno-assays) the driving force is relatively passive by absorbance and therefore less reproducible and slow especially across a longer path.

The present invention provides a reversed lateral flow-through device for analytes detection, comprising: (a) one or more reaction chambers, each of which comprises one or more membrane for immobilizing capture molecules capable of capturing target analytes; (b) controlling elements that can be regulated to maintain the reaction chamber in controlled conditions; (c) connecting elements for connection to a power supply and control unit that can regulate and maintain the controlled conditions (e.g. accurate temperature setting, solution flow direction as well as individualization for different cell compartments or sample assays etc.); and (d) liquid delivery elements capable of accepting and removing solution to and from the reaction chambers, wherein the solution is maintained in a flow direction that flows against gravitational force, and the solution flows through the membrane from one end to another end so that target analytes pass through the capture molecules immobilized on the membrane, thereby providing higher sensitivity of analytes detection.

In one embodiment, the membrane can be made of materials such as nitrocellulose, nylon, Nytron, Biodyne, or Porex. In another embodiment, the membrane can be any porous materials capable of immobilizing the corresponding capture probes for target binding and detection. In general, the power supply and control unit is capable of supplying energy and providing regulatory control to maintain the reaction chambers in the controlled conditions, whereas accepting and removing solution to and from the reaction chamber is by regulated liquid pumping. In one embodiment, the liquid pumping is used to recirculate solution containing the target analytes through the membrane. In yet another embodiment, the reaction chambers are disposable or each of the reaction chambers is a separate unit.

The present invention also provides a reversed lateral flow-through analytes detection system comprising more than one of the devices described above, wherein the devices are connected to a power supply and control unit capable of supplying energy and providing regulatory control to the devices. In one embodiment, each of the devices is controlled independently by the power supply and control unit so that each device can perform different analysis under different conditions.

The present invention also provides a method of performing a rapid analysis for a target analyte, comprising the steps of: (a) obtaining a sample comprising a target analyte; (b) applying the sample to an array comprising capture molecules that will capture the target analyte on the array, wherein the sample flows through the array from one end to another end of the array in a flow direction that is against gravitational force; and (c) detecting the captured target analyte on the array. Generally, the target analyte can be a protein molecule, a nucleic acid molecule, or a combination of protein and nucleic acid molecules.

In one embodiment, the target is a protein molecule of human, bacterial, or viral origin. In another embodiment, the human is having or is suspected of having cancer. In general, the protein molecule can be detected by fluorescence tags, quantum dot labeling, colloidal gold particle labeling, magnetic particle labeling, or enzyme-linked substrate assay. In one embodiment, the protein sample is mixed with a signal generating agent before being applied to the array.

The present invention also provides a method of performing rapid nucleic acids detection, comprising the steps of: (a) obtaining a sample comprising a target nucleic acid molecule; (b) mixing the nucleic acid molecule with a first probe and a second agent, wherein the first probe will bind to the nucleic acid molecule, and the second agent will bind to the first probe, thereby forming a nucleic acid molecule complex in solution; (c) applying the sample to an array comprising a third probe that will bind to the nucleic acid molecule complex, wherein the sample flows through the array from one end to another end of the array in a flow direction that is against gravitational force; and (d) detecting the captured target molecule on the array. In one embodiment, the nucleic acid can be DNA, RNA or nucleic acid-protein complex. In another embodiment, the nucleic acids may comprise modified DNA bases such as Methylation and/or acetylation. Detection of captured nucleic acid molecule can be performed by fluorescence tags, quantum dot labeling, colloidal gold particle labeling, magnetic particle labeling, or enzyme-linked substrate assay.

The present invention also provides a method of performing rapid nucleic acids detection, comprising the steps of: (a) obtaining a sample comprising a target nucleic acid molecule; (b) mixing the nucleic acid molecule with a first probe, a first antibody and a labeling agent, wherein the first probe will form a complex with the nucleic acid molecule, and the first antibody will bind to the resulting complex; (c) applying the sample to an array comprising a second antibody that will bind to the first antibody, thereby capturing the nucleic acid molecule complex on the array, wherein the sample flows through the array from one end to another end of the array in a flow direction that is against gravitational force; and (d) detecting the captured target molecule on the array. Representative examples of nucleic acid molecules and detection methods have been described above.

The present invention also provides a method of performing rapid nucleic acids detection, comprising the steps of: (a) obtaining a sample comprising a target nucleic acid molecule; (b) modifying the nucleic acid molecule by disulfide treatment, thereby changing a methylated CG into TG, whereas unmethylated CG remains unchanged; (c) amplifying the nucleic acid molecule; and (d) applying the sample to a device of the present invention that contains an array comprising probes that will detect target sequences comprising methylated or unmethylated CG, thereby capturing the target sequences on the array; and wherein the intensity of hybridization of each pair of methylated and unmethylated CG will determine the extent of methylation on the target sequences, and the pattern of hybridization on the array would provide a methylation profile. Representative examples of nucleic acid molecules have been described above.

In summary, the present invention provides a general platform for substantial improvements in sensitivity, specificity and efficiency in performing general analytes detection assays. The device and methods described herein can be applied to any analytes of interest, for example, the present invention is applicable to genotyping of any gene(s); analysis of epigenetic changes of gene(s) and modifications of any target sequences in the genome; analyzing specific proteins (gene products); and determination of protein profiles. Any target analytes, metabolites or any biomolecules for which there are capture molecule(s) having high binding affinity can be detected by the device and methods of the present invention.

The invention being generally described, will be more readily understood by reference to the following examples which are included merely for purposes of illustration of certain aspects and embodiments of the present invention, and are not intended to limit the invention.

### Example 1

### Reversed Flow-Through Array System

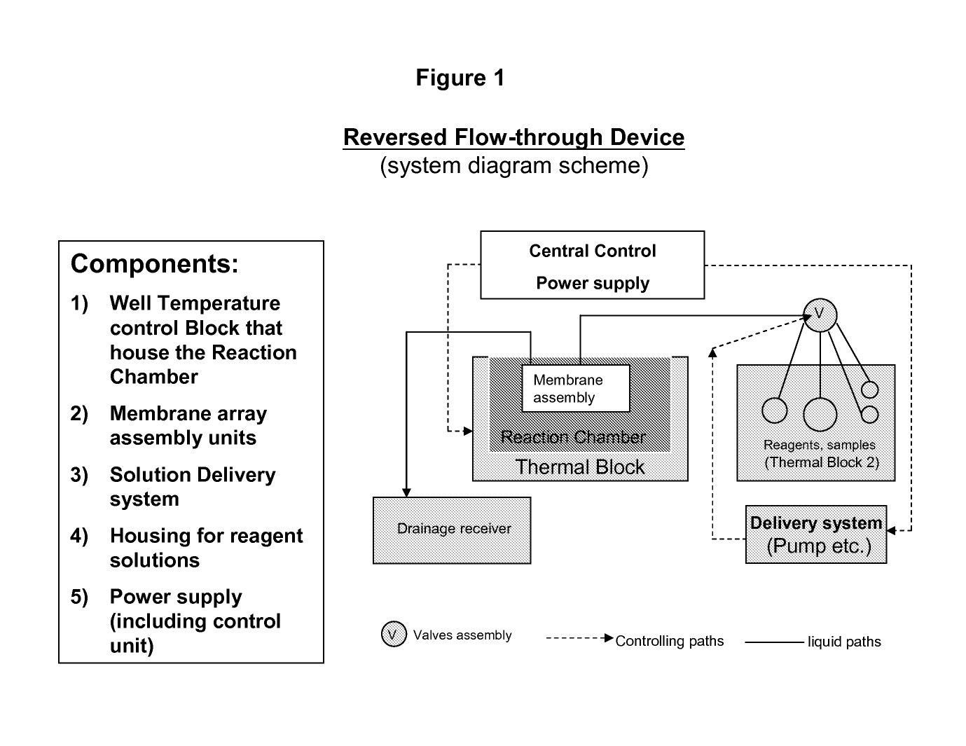

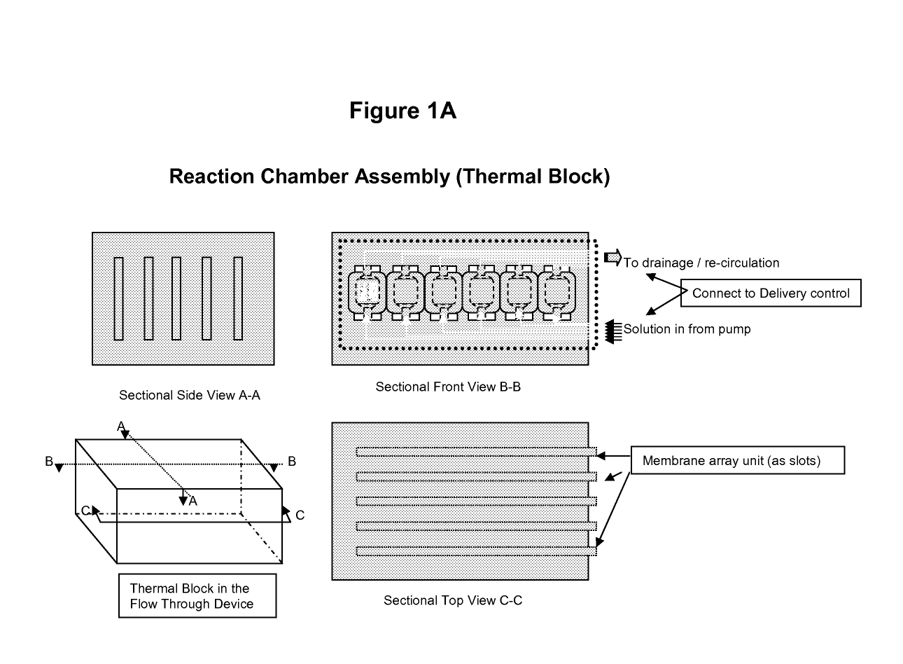

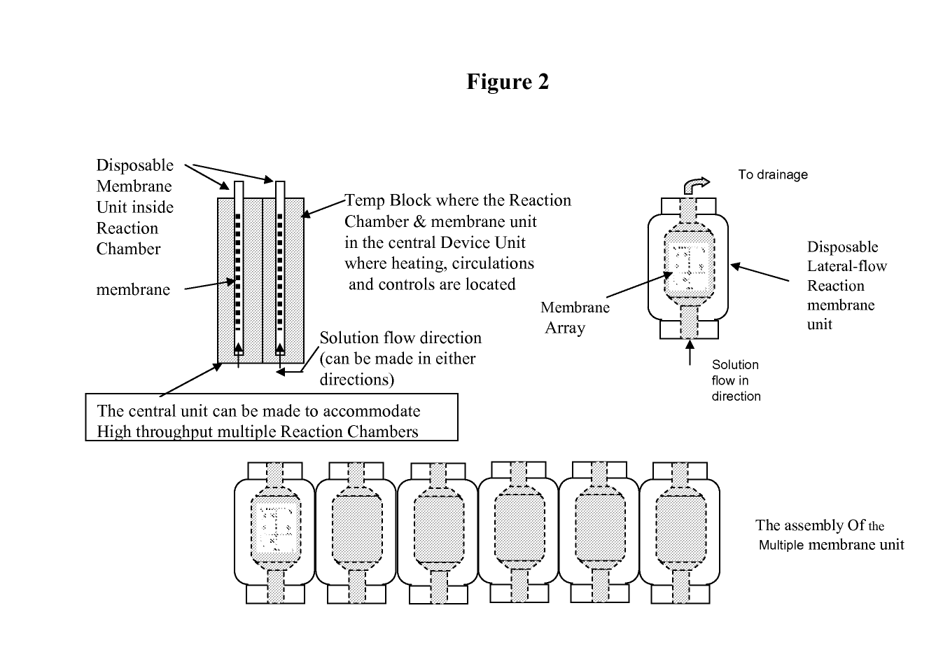

Certain embodiments of flow-through detection device have been described (see Tam, 1998; 2004; 2005; 2006). FIG. 1 shows an exploded view of a Reversed Lateral Flow-through detection device of the present invention

FIG. 1 shows one embodiment of a reversed flow-through hybridization device comprising a controlling unit, a reaction chamber and membrane array unit, and the connections of the reversed lateral flow system. The controlling unit provides power to and controls the flow system connected to the chamber where hybridization process and signal developing procedures are carried out. Several reactions (or several samples and/or analytes) can be tested simultaneously in a single reaction chamber containing multiple membrane arrays and/or in several reversed flow-through devices controlled individually at different conditions. The membrane can be any format such as an array in n×m dot matrix or linear arrays. Since during the reaction process, the test solution flows from one end of the membrane to the other end, the sensitivity of detection is increased substantially compared to normal direct flow through across the membrane thickness. The extent of increase in sensitivity depends on the ratio of the total area of the membrane to the area of the dot or line containing the capturing probes. For example, assuming the total area of the membrane is 100 mm square, and the dot size is 1 mm in diameter. In a direct flow-through process (i.e., the solution flows from top surface through the membrane down to the other side of the membrane as in a conventional flow-through process), only 0.78% of the total test solution used will flow through the dot, the location where the target molecule will bind to the probe(s) immobilized on the membrane. However, if a lateral flow-through process is used, the sensitivity is dependent on the ratio of the width of the dot to the width of the membrane (i.e., the cross section of the membrane). For instance, in a lateral flow-through process, the total amount of solution that will pass through a 1 mm diameter dot provided on a 10 mm×10 mm membrane will be about 1/10, which represents a 12-fold increase in sensitivity using the same amount of test solution containing the target molecules. When a line array format is used, lateral flow-through process will produce the highest sensitivity (i.e. a 120 folds increase compared to the direct flow through system) since all the target molecules will pass through the line extending across the strip (or membrane). Hence, the reversed lateral flow-through process of this invention allows quantitative measurements to be taken during the hybridization process because the flow of the analytes is much more uniform compared to that produced in prior arts.

Alternative embodiments for the reversed lateral flow-through device can be constructed by incorporating a recirculation system into the unit. Repeated flow through process allows exhaustive binding of the target molecule. Evidently this embodiment can provide optimal conditions for effective detection with increased sensitivity and specificity to the highest possible extent. The disposable membrane assembly as well as the totally enclosed setting in this embodiment can prevent any possibility of cross contamination. Hence this is an ideal format for detecting trace amount of analytes where excessive amplification such as PCR may cause product contamination.

### Example 2

### Protein Biomarkers Assay For Cancer

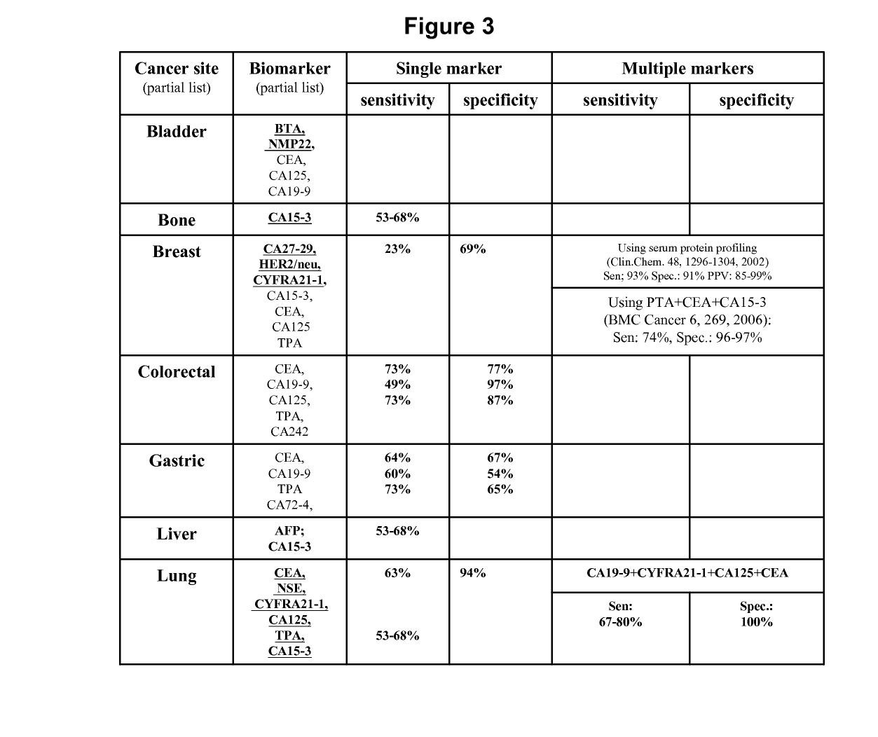

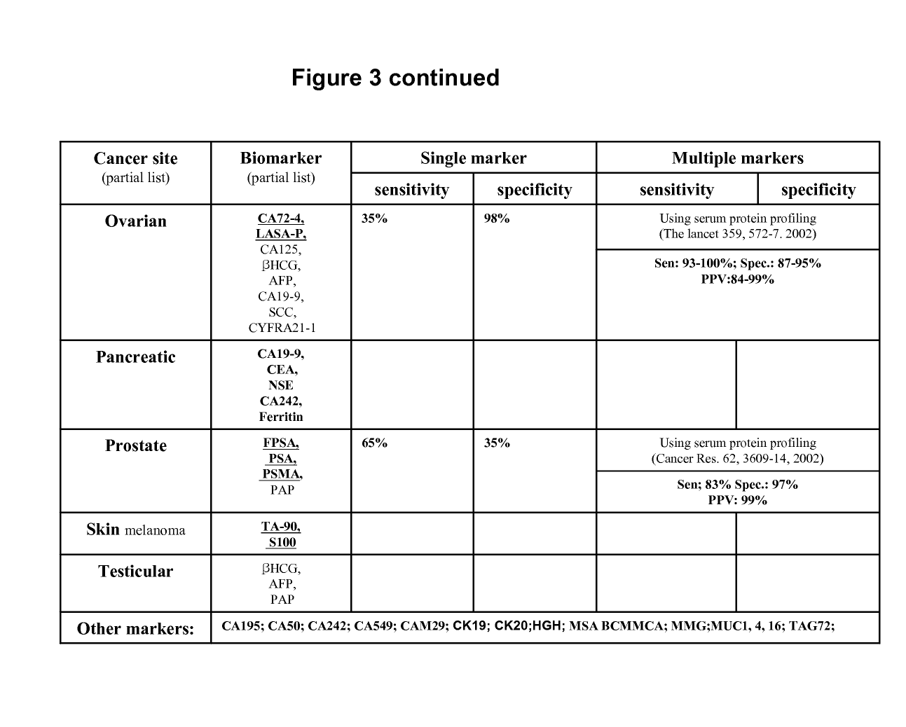

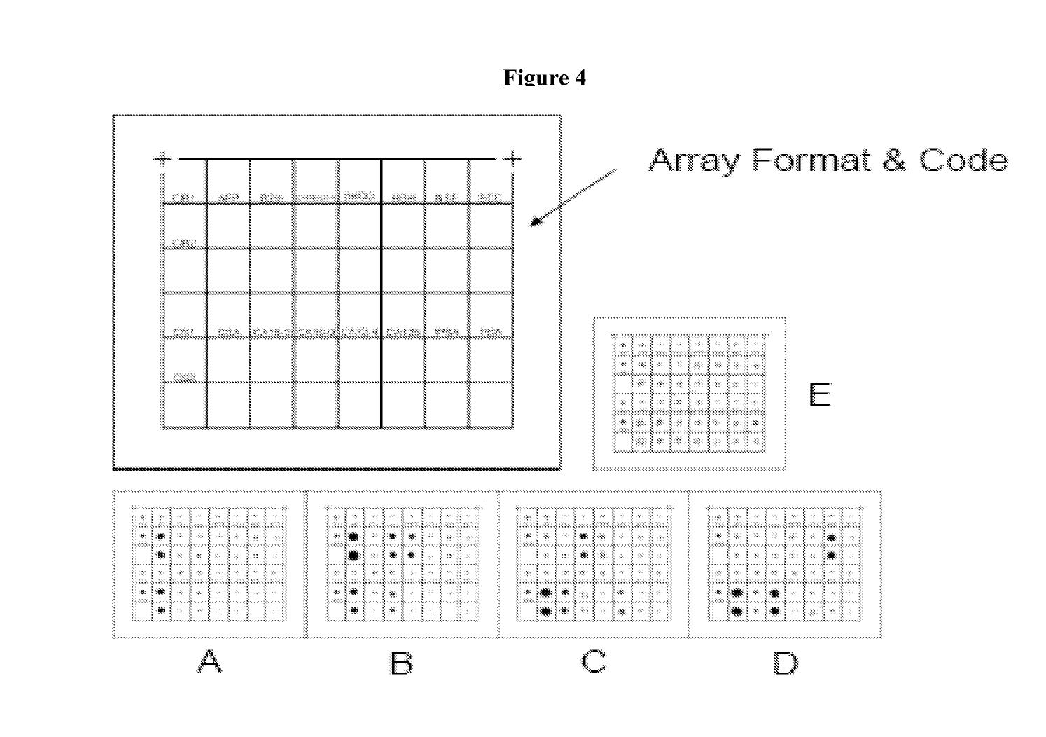

The reversed flow-through array described herein can generate useful profiles by simultaneously assaying multiple biomarkers in a single assay. FIG. 3 shows some of the biomarkers useful for cancer screening in clinical laboratories. Although an individual marker may have some prognostic value, a single marker alone cannot provide significant sensitivity and specificity for the diagnosis of solid cancers. Quantitative profiles of a group of markers would be much more useful in delineating possible types of cancer and to get a more accurate early diagnosis. FIG. 4 shows a typical set of profiles and their corresponding cancers. Preliminary data suggested that using such profiles generated from the reversed flow-through arrays would provide more sensitive and specific assays for cancer diagnosis. These profiles and diagnosis can be further validated through large clinical trails.

In another embodiment, the present invention can simultaneously detect multiple proteins of different organisms such as viruses and/or bacteria. For example, phenotyping of drug resistant proteins in human such as P450 or viral proteins of HIV, HCV can be conducted singularly or in combinations.

### Example 3

### Genotyping of Metabolic Enzymes

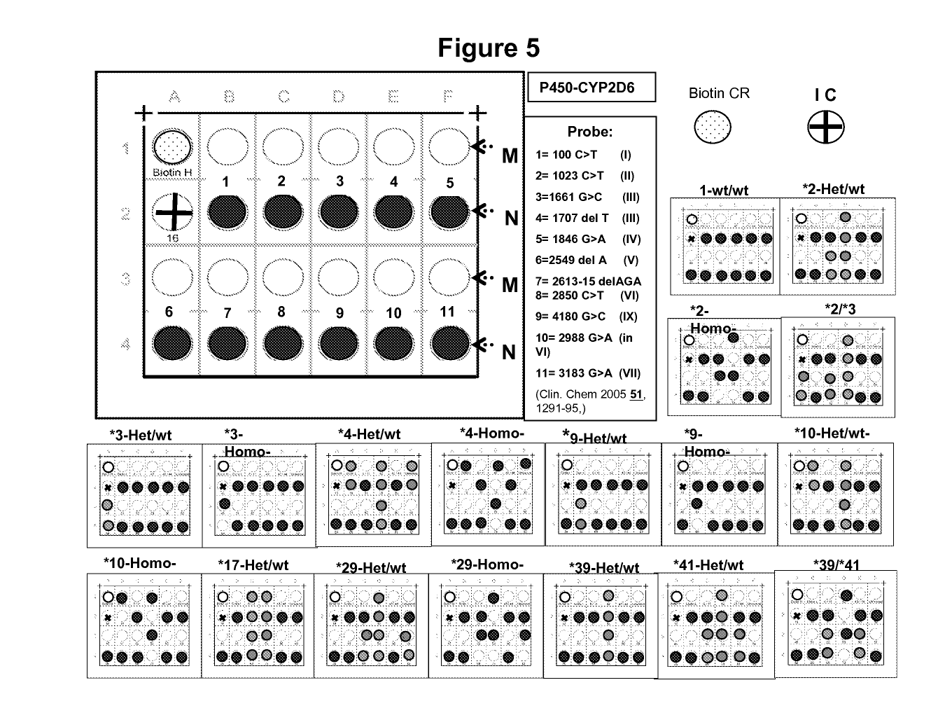

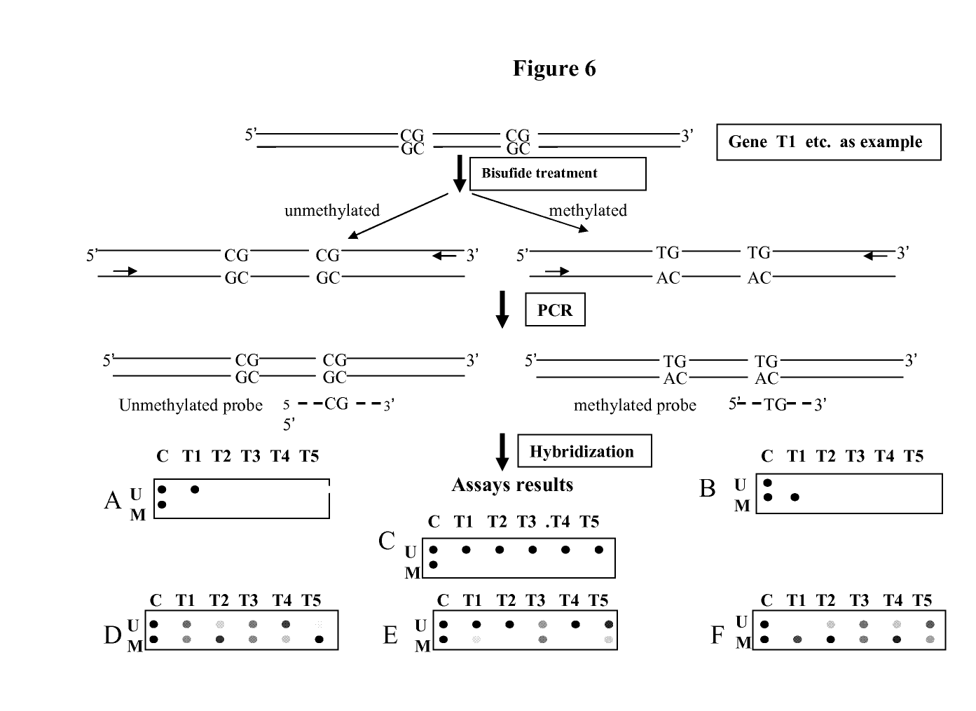

The device and methods described herein can be used for genotyping of metabolic enzymes. Detailed analysis on the activity of first line metabolic enzymes such as CYPs has been found crucial for drug efficacy because different genotype may have drastically different activity in converting drugs into effective metabolites for proper function. Hence knowing their genotype may be a prerequisite for prescribing drugs for effective treatment. As an example, FIG. 5 shows some of the SNP arrays used in the reversed flow-through system for genotype determination.

### Example 4

### Cancer Early Detection Panels

The device and methods described herein can be used to develop a number of cancer detection panels. The cause of cancer is undoubtedly genetic in origin. Therefore if any genetic trait is identified, early detection is possible before tumorgenesis progresses into disease stages, which normally takes many years. The majority of cases in cancers are sporadic cases, due to either somatic mutations or structural modification of genes during one's life span. The longer one lives, the higher the concentration of mutated gene(s) that will accumulate in an individual. Consequently, functionally defective phenotypes (by either reducing the level of expression or producing defective gene product) occur that leads to onset of tumorgenesis. In principle, genetic profile of a group of genes can be generated in the form of (i) expression level; (ii) the accumulation of defective products or (iii) the presence of genetic alterations such as DNA mutation(s) in the responsible gene(s) and/or alteration of the controlling region(s), e.g. promoter or enhancer. Such profile should provide insights into when and how tumorgenesis may occur and present diagnostic and prognostic assays.

Indeed mutation (s) of various genes have been identified to have definitive association with certain cancers such as the BRCAs gene for breast cancer; APC gene for colon cancer; p53 gene and Kras for cancers of multiple origins in human. Moreover, hypermethylation in the promoter region mostly located in the CpG islands will lead to silencing of tumor suppressor genes and induction of sporadic cancer. Since alteration(s) in the DNA is the prerequisite condition for cancers, detection of such mutation(s) and/or methylation status would be the earliest possible assay for preventive healthcare. Genes that are normally active will become inactive when their promoter region (or any regulatory regions) CpG islands are methylated. On the other hand, when genes are normally inactive, demethylation shall make these genes active, thereby resulting in abnormal function. Hence the methylation example can also be extended to the detection of hypo-methylation (as compare to hypermethylation discussed below).

Recently, epigenetic studies have gained a lot of momentum. Hypermethylation of a number of genes have been reported and hypermethylation on these genes was found to be closely linked to cancer progression. These have led to the development of Methylation Specific Quantitative Real Time PCR (MSQ-PCR) in an attempt to give early diagnosis (Lo et. al., 1999; Facker et. al., 2006). However, despite its sensitivity, MSQ-PCR has its limitations. Firstly, the maximum number of color dyes is 6 and therefore only 3 genes' CpG islands can be tested simultaneously in a single reaction mixture. This is far less than the number of genes required to produce accurate and meaningful result. Secondly, since sample is often limited in quantity, it is not possible to repeat tests on other genes to confirm the presence or absence of cancer and to identify the type and site of cancer present.

In contrast, the devices and methods of this invention can be applied for multiplex amplification and array assay which can screen a high number of genes or sequences simultaneously, thereby giving a much higher probability for early cancer diagnosis. Recent reports strongly indicated that mutations as well as epigenetic changes for many genes are thought to be associated with cancers and suggested that they would be good cancer markers (Sidransky, 2002). Other genes are responsible for regulation of metabolic pathways leading to cell homeostasis. Disruption in the expression of these regulatory genes would lead to uncontrolled growth and cancers (Shinozaki et. al., 2005; Yu et. al., 2004). Consequently, mutation profiles as well as hypermethylation profiles of these genes would be ideal for early screening, diagnosis and in some cases prognosis application. The reversed flow-through process of the present invention would provide an ideal tool for accurate determination of these gene profiles for cancer diagnosis.

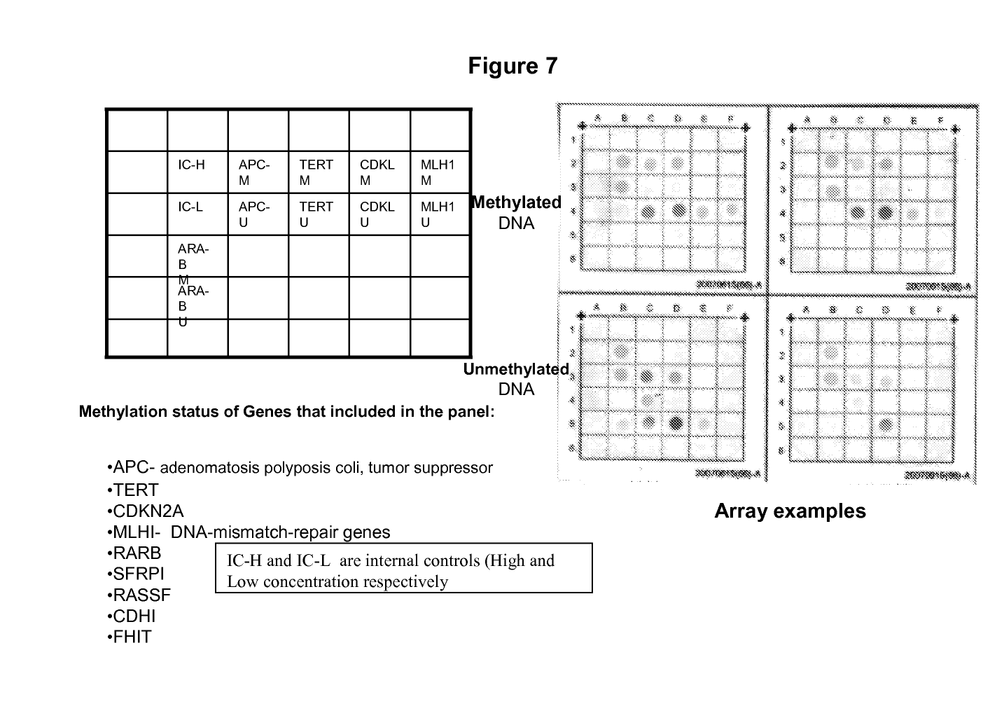

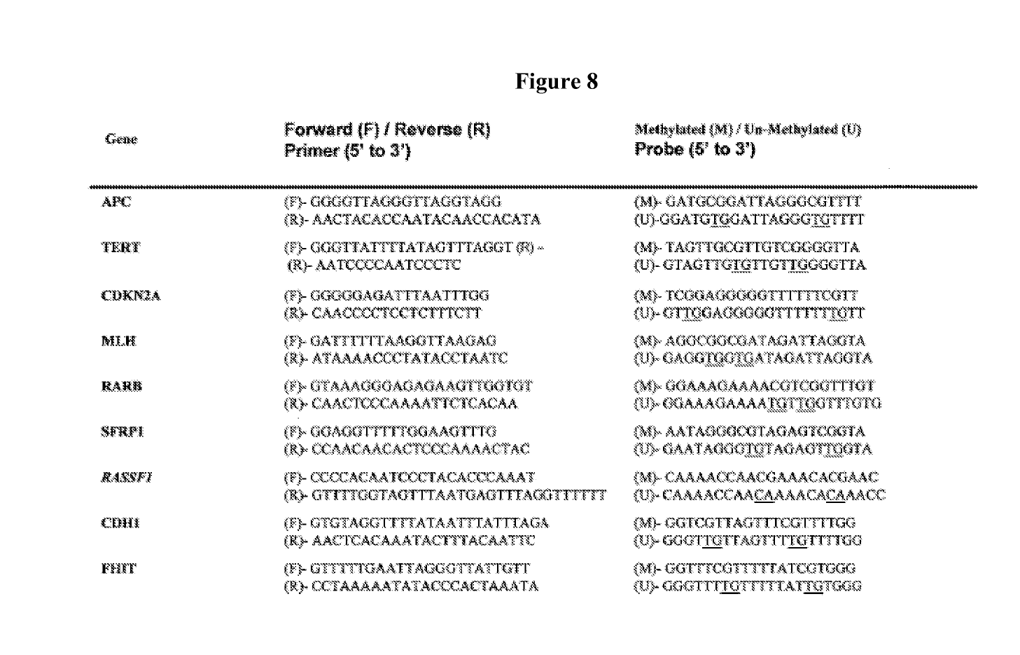

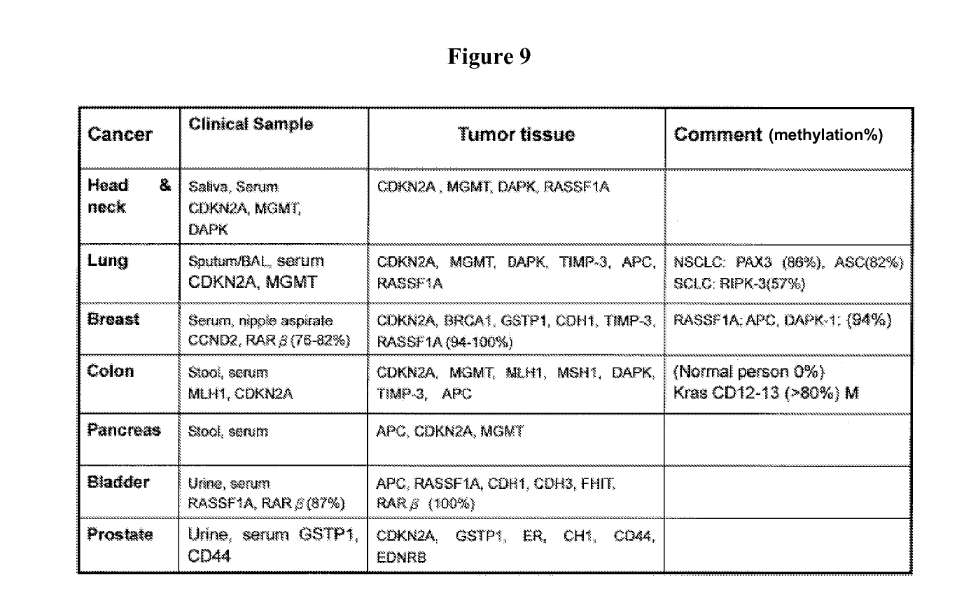

FIG. 7 shows examples of different array formats for generating gene profiles on methylation(s). Similar mutations profiles and expression profiles of mRNAs can also be done by such flow-through arrays. Cancers that occur in different parts of the human body (or organ) are expected to have different gene expression profiles. The methods and devices disclosed herein would provide distinctive profiles on gene mutations and/or the extend of methylation of CpG islands on a set of corresponding genes that will have significant diagnosis and prognosis value for the identification of cancer in different parts of the human body. FIG. 8 shows some of the primer and probe sequences useful for methylation detection. Some of the prospective markers and genes for methylation assays and their possible association to cancers are listed in FIG. 9. Results from flow-through arrays experiments suggested that using such profiles provided more sensitive and specific assays for cancer diagnosis. It is specifically important to point out that DNA methylation can provide a definitive way to confirm any suggestive results from Biomarker assays. Examples of biomarker detection are given in Example 2 above.

### Example 5

### One-Step Flow-Through Assay

A one-step flow through assay can be used in the device and methods described herein. Conventional hybridization and related assays are very time consuming because of complicated procedures that involve many separate steps. The reversed flow-through process and the device described herein have simplified the operation and resulted in substantial reduction of time and reagents cost without scarifying sensitivity and specificity for detection. The invention disclosed herein would provide procedural improvements and expand the scope of testing.

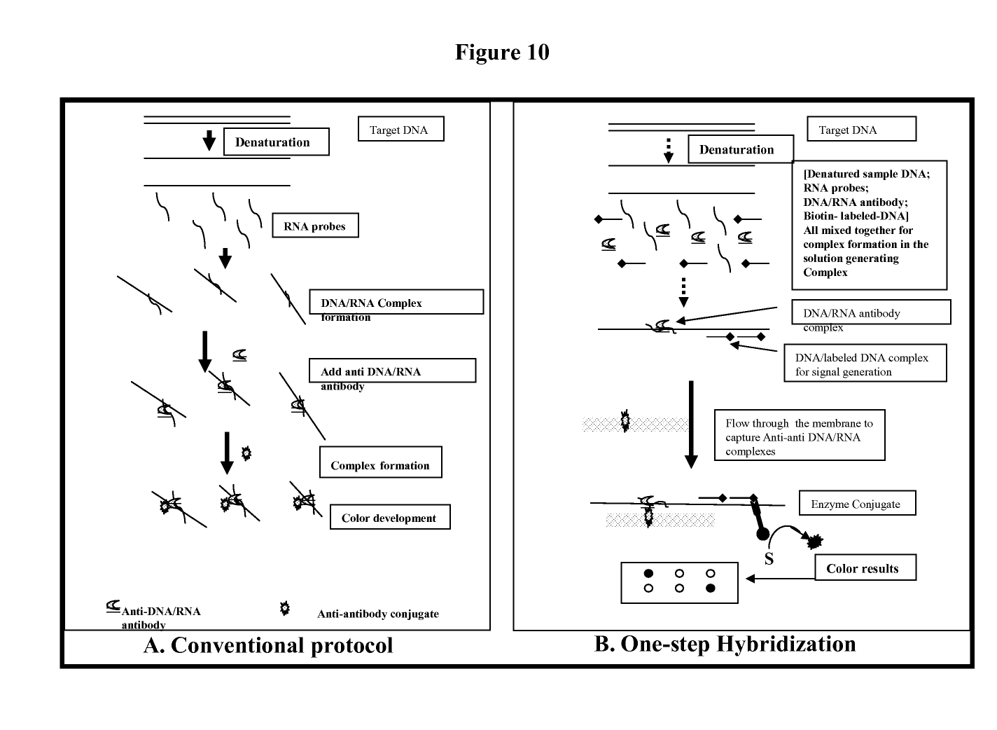

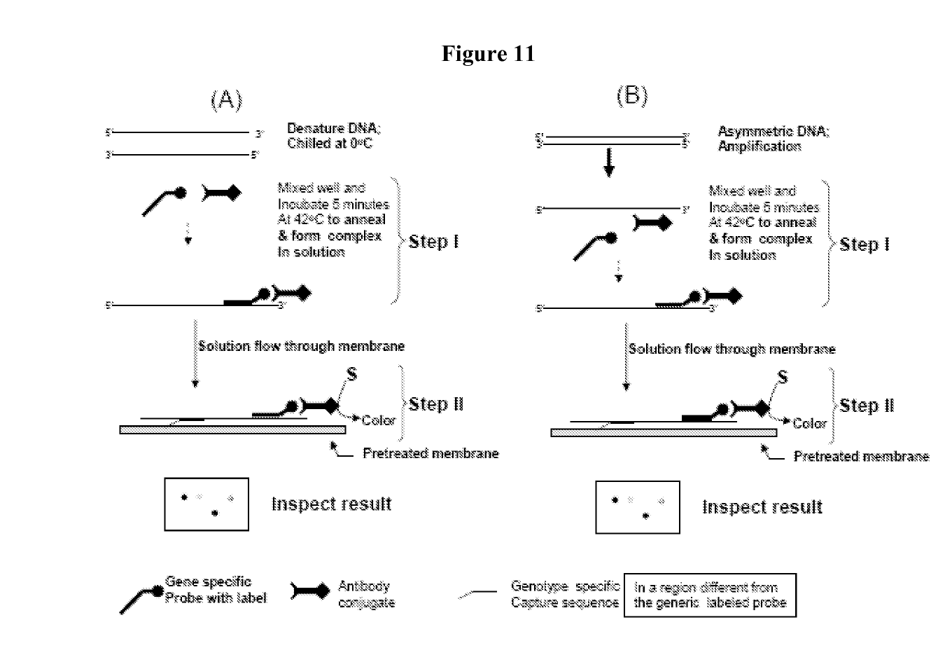

FIG. 10 shows the scheme of a sample protocol: (i) after amplification, the amplicons are denatured, chilled to prevent self annealing, then mixed with hybridization reagents and incubated at predetermined hybridization temperature for 5 minutes before being dropped into the reaction site (the membrane) for capture and signal inspection; (ii) signal development by adding substrate for color development.

Other than those outlined in FIG. 10, the following steps will help to achieve better results: (a) asymmetric amplification by PCR or equivalent method to generate more single strand copies in complementary to the capture probe(s); (b) strepavidin labeling for signal generating tags and this conjugate shall be used for interacting with the biotin-labeled target DNA molecule to give signal; and (c) the number of signal development procedures will depend on the kind of labeling tags used either during amplicon generation or the signal developing conjugate. The use of fluorescence dyes in amplicon production or direct color labeling of the conjugate will eliminate subsequent color development steps after hybridization. Otherwise similar color development steps by conventional enzyme-linked conjugate plus substrate can be used.

Besides fluorescence tags, a single-step hybridization process can label target sequences or molecules with quantum dot, colloidal gold particles, magnetic particles or other appropriate labeling tags to eliminate the enzyme-linked conjugate substrate color development step. These improvements will enable a technician to complete the entire hybridization process and signal production in 5 minutes or less. Hence, the method of the present invention should provide further savings in terms of time and reagent cost.

FIG. 9 illustrates an example of how the single-step hybridization can be performed. With adequate concentration of analytes (either in the form of sample volume or concentration, i.e. if the total number of analytes molecules is enough) and appropriate signal generating labeling tags, direct analyses on the original sample without amplification may be possible by flowing the sample solution (after thoroughly mixed well with all reagents to provide analyzable complexes) continuously through the membrane on which target molecules have been captured by immobilized probes to generate detectable signal similar to the over-the-counter immunochemical strip testing kits.

### Example 6

### A Novel Signal Amplification Assay

A novel signal amplification assay can be used in the device and methods described herein. Contamination can be a serious problem for PCR reactions. Hence, instead of product amplification by PCR, molecular biology or DNA-based diagnosis can be enhanced by an alternative strategy of signal amplification. Branch DNA (b-DNA) has been and still is being used with certain success. DNA super molecular complexes are also under investigation. Recently the hybrid capture technology for HPV detection is another example. Unfortunately, these methods are neither suitable nor applied to membrane-based assays.

The present invention presents examples of membrane-based application using the reverse flow-through platform. As shown in FIG. 10, the detection system includes: (1) sequence-specific capturing oligo-probes immobilized onto membrane as detection arrays; (2) specific RNA or DNA oligos are designed for binding with target DNA molecules in the sample solution; (3) polyclonal antibody specific to DNA/RNA molecules, having high affinity to DNA/RNA complex in general but not sequence specific for capturing the DNA/RNA molecule in target sample solution; (4) antibody specific to anti-DNA/RNA for binding and concentrating the antibody-DNA/RNA complex in the target solution; (5) signal generating tags-labeled DNA molecules in the region(s) other than those used for the captured RNA and DNA oligos immobilized on the membrane; and (6) reagents for signal development and device.

The method steps include: (1) DNA isolated and purified from target sample in adequate quantity is denatured, chilled and mixed with RNA capture oligos hybridized in the presence of appropriate amount of anti-DNA/RNA antibody to form complex; (2) the complex is then recovered by affinity column to be concentrated; (3) the complex is re-suspended, equilibrated at required temperature and flow through the membrane for hybridization and wash; (4) DNA tags is added, washed, followed by signal development and report. The procedure described above is the initial experimental approach. Further optimization can be done in accordance to the concept and spirit of this invention.

In principle, single step is possible by putting in appropriate components together in the sample solution (i.e. after deproteinization to exclude cell debris and non-nucleic acid complexes) and flow into the membrane for hybridization capture. The present invention employs detection assay direct from the neat solution sample (the starting sample) without amplification. It is applicable and enabled using the flow-through system because there is no limitation on the solution volume used. The sensitivity of detection varies according to the signal generating system used. For example, using the AP-AV and color development system we had achieved 0.3 fetomole/label. At least ten-fold increase in sensitivity can be achieved by chemiluminescence assay. By increasing the number of label molecule in the signal DNA tag, detection in the range of attomole is achievable in principle. At this concentration many of the viral infections can be readily detected.

### Example 7

### Procedures for the Flow-Through Process

The flow-through array system described herein can be use for dot-blot, reversed dot-blot or slot blot analysis, where multiple array assays can be done simultaneously.

### Dot-Blot

When used as dot-blot, target samples to be tested are dotted onto the membrane as arrays in each well (separated from the other wells) for which the number of well depend upon the number of antibodies (for antigen screening) or antigens (for antibody screening). The following is exemplified for antigens screening:

### Procedures:

1. Immobilized a set of samples onto a number of wells on the membrane and fixed as array. A membrane refers to any porous matrix materials capable of binding the target antigens for detection.

2. Block the membrane to prevent non-specific binding.

3. Flow-through solution containing antibody molecule to be targeted for detection; wash followed by signal detection (no further step is needed if signal generating dye has been labeled onto the antibody).

4. Develop color according to standard assay procedures (see e.g. Tam et. al., 1988).

### Reverse Dot-Blot

In the Reverse Dot-Blot, a different type of antibodies (or antigens) are being dotted in array format for screening their complement molecules in the target sample solution:

### Procedures:

1. Immobilized a set of antibodies (for capturing antigenic proteins or antigens) or antigens (for capturing antibodies) onto a membrane or any matrix materials for detecting target molecules

2. Block the membrane to prevent non-specific binding. This step can be deleted if the membrane has been pretreated with blocking reagents.

3. Flow-through the solution containing target molecules; wash followed by signal detection (no further step is needed if labeled detection second antibody is added into the target solution in appropriate conditions).

4. Develop color according to standard assay procedures (see e.g. Tam et. al., 1988).

Slot Blots can be done either as Dot-blot or Slot-Blot as described above.

### Western Blot Assays

Western Blot has been a useful technique for the analysis of target protein(s) in a solution in question for definitive identification. The general procedures are: (1) separate the protein molecules as far as possible in a mixture of proteins by either conventional SDS electrophoresis or isoelectric focusing (IEF) in order to generate a clean and observable bands; (2) transfer the protein onto a membrane; and (3) assayed by antibody binding (by affinity) followed by color development. This is, however, a very time consuming process requiring days or hours to perform. In the post genomic era, protein expression profiles are in the center stage for targeting novel discovery of proteins or drug developments.

The present invention provides a rapid platform (the flow-through device's reaction chamber) for carrying out all the steps of Western Blot after the protein has been transferred onto a membrane. The platform will provide for rapid immuno-reaction between target molecules and their reactants (e.g. antibodies or antigens). The procedures involved are similar to that of the Dot-Blot analysis from Step 2 to 4 described above.

In another embodiment, the present flow-through system can be used for rapid screening for the presence or absence of target proteins before the long electrophoresis separation and transfer processes. In this case, one can use the flow-through process and Dot-blot to screen many samples to see if the target protein is present in 20-30 minutes before conventional Western Blot with electrophoresis separation and transfer is done. Since dot-blot is a rapid and high through-put assay, the flow-through system will save 10-100 folds in time and materials. Furthermore, using a recirculation flow-through system disclosed herein would even further increase the sensitivity of the assay.

### EQUIVALENTS

The disclosures in connection with preferred embodiments are not intent to limit the invention to the procedures and embodiments described. On the contrary, the intent is to cover all alternatives, modifications, and equivalents as may be included within the spirit and scope of the invention as defined by the appended claims.

Those skilled in the art will recognize, or be able to ascertain using no more than routine experimentation, many equivalents to the specific embodiments of the invention described herein. For example the procedures used for protein blotting in the above can be readily modified to adopt to nucleic acids detections where the antibody antigen probes are replaced with corresponding nucleic acids probes and amplification such as PCR may have to be added in order to produce sufficient target molecules for effective detection. Such equivalents are intended to be encompassed by the following claims.

### REFERENCES

Bunce M et al. (1995) Tissue Antigens, 46, 355-367.
Chakraborty R, Stivers D N. Paternity exclusion by DNA markers: effects of paternal mutations. J Forensic Sci 1996 July; 41 (4): 671-7.
Chow R and Tonai R., “High throughput methods for HLA typing”, U.S. Pat. No. 6,670,124, Dec. 30, 2003.
Grondahl et. al., Journal of Clinical Microbiology 1999 January; 37: 1-7
Kaneshige T et. al., Rapid and Practical HLA Class II Genotyping by Reversed Dot Blotting, Transplantation Proceedings, 1993 February; 25(1): 194-198.
Mach B et al. (1990) in Molecular Biology of HLA Class II Antigens, ed. Silver J (CRC, Boca Raton, Fla.), pp. 201-223.
Mach et al., “DNA sequences coding for the DR beta-chain locus of the human lymphocyte antigen complex and polypeptides, diagnostic typing processes and products related thereto”, U.S. Pat. No. 6,818,393, Nov. 16, 2004.
Mackay et. al. Journal of Clinical Microbiology 2003 January; 100-105
Tam, Flow Through Nucleic Acid Hybridization Device, U.S. Pat. No. 5,741,647.
Tam, Flow Through Nucleic Acid Hybridization Device, U.S. Pat. No. 6,020,187.
Tam, DNA Fingerprinting Using Allelic Specific Oligonucleotide Reversed Dot Blot (ASO RDB) Flow Through Hybridization Process And Device, U.S. Publication No. 2005/0079493, Apr. 14, 2005.
Tam, SNP-BASED HLA-DP, DR And DQ Genotyping Analysis By Reverse Dot Blot Flow Through Hybridization, U.S. Publication No. 2004/0209253, Oct. 21, 2004.
Tam, Rapid Genotyping Analysis and the Device Thereof, U.S. Publication No. 2006/0292601, Dec. 28, 2006.
Thomas E D (1983) J. Clinical Oncology 1, 517-531.

1. A reversed lateral flow-through apparatus for analytes analysis, comprising:
(a) one or more reaction chambers, each of which comprises one or more membranes for immobilizing capture molecules capable of capturing target analytes or, one or more arrays of capture probes adapted for capturing target molecules;
(b) control elements that can be regulated to maintain the reaction chamber in controlled conditions;
(c) connecting elements for connection to a power supply, a control unit for regulating the control elements to maintain the controlled conditions; and
(d) a liquid delivery arrangement capable of delivering and removing a solution comprising the target analytes to and from the reaction chambers, wherein the liquid delivery arrangement is arranged to cause the solution to flow through the one or more membranes or arrays of capture probes against gravitational force so that target analytes can pass through, react with the capture molecules immobilized on the membrane, or capture probes, and be identified.

2-45. (canceled)

46. An apparatus according to claim 1, wherein the control unit is arranged to maintain the one or more reaction chambers in controlled thermal conditions.

47. An Apparatus according to claim 46, wherein the control unit is adapted for controlling flow rate, and preferably for maintaining a uniform flow rate across a length of the membrane.

48. An apparatus according to claim 47, wherein the liquid delivery arrangement comprises means for producing a positive driving force to drive the solution across the membrane against gravitational force, such as a pump.

49. An apparatus according to claim 48, further comprising an arrangement to re-circulate the solution through the one or more reaction chambers during use.

50. An apparatus according to claim 49, wherein the one or more membranes comprises a porous matrix array, preferably a porous matrix array which is capable of binding a target analyte with antigens.

51. An apparatus according to claim 46, wherein the one or more membranes comprises a porous matrix array, preferably a porous matrix array which is capable of binding a target analyte with antigens.

52. An apparatus according to claim 51, wherein the control unit is adapted for controlling flow rate, and preferably for maintaining a uniform flow rate across a length of the membrane.

53. An apparatus according to claim 51, wherein the liquid delivery arrangement comprises means for producing a positive driving force to drive the solution across the membrane against gravitational force, such as a pump.

54. An apparatus according to claim 52, further comprising an arrangement to re-circulate the solution through the one or more reaction chambers during use.

55. An apparatus according to claim 53, wherein the one or more membranes comprises a porous matrix array, preferably a porous matrix array which is capable of binding a target analyte with antigens.

56. An apparatus according to claim 1, wherein the membrane is arranged to capture target analytes selected from a group consisting of proteins, nucleic acids, and nucleic acids comprising modified bases.

57. An apparatus according to claim 1, wherein the membrane comprises a material selected from a group consisting of nitrocellulose, nylon, Nytron, Biodyne, and Porex.

58. An apparatus according to claim 1, wherein the one or more membranes comprises a porous matrix array, preferably a porous matrix array which is capable of binding a target analyte with antigens.

59. An apparatus according to claim 1, wherein the one or more reaction chambers are arranged to facilitate a hybridization process.

60. An apparatus according to claim 1, wherein the one or more membranes are arranged as a disposable membrane array unit within the reaction chambers.

61. A method of performing a rapid analysis of a target analyte, comprising the steps of:
(a) obtaining a sample comprising a target analyte;
(b) applying the sample to an array comprising capture molecules or capture probes that will capture the target analyte on the array, wherein the sample is forced to flow through the array from one end to another end of the array in a flow direction that is against gravitational force; and
(c) detecting the captured target analyte on the array.

62. The method of claim 61, wherein the target analyte is selected from the group consisting of a protein molecule, a nucleic acid molecule, and a combination of protein and nucleic acid molecules; and/or the protein molecule is of human, bacterial, or viral origin.

63. The method according to claim 61, wherein the method further comprises maintaining thermal conditions of the array.

64. The method according to claim 63, wherein the protein molecule is detected by a method selected from the group consisting of fluorescence tags, quantum dot labeling, colloidal gold particle labeling, magnetic particle labeling, and enzyme-linked substrate assay.

65. The method according to claim 61, wherein the sample is mixed with a signal generating agent before being applied to the array.

66. The method according to claim 61, wherein the protein molecule is detected by a method selected from the group consisting of fluorescence tags, quantum dot labeling, colloidal gold particle labeling, magnetic particle labeling, and enzyme-linked substrate assay.
